(19) United States
(12) Patent Application Publication
(10) Pub. No.: US 2006/0193974 A1
(43) Pub. Date: Aug. 31, 2006

(54) Production method for chip-form film-forming component

(75) Inventor: Tadayuki Kurihara, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Tochigi (JP)

(21) Appl. No.: 10/550,018

(22) PCT Filed: Jun. 9, 2004
(86) PCT No.: PCT/JP04/08028

§ 371 Date: Sep. 23, 2005

(30) Foreign Application Priority Data
Jun. 9, 2003 (JP) 2003-163294

(51) Int. Cl. B05D 5/06

(52) U.S. Cl. 427/162; 427/331

(57) ABSTRACT

To prevent a substrate and films from being deformed or damaged when a very large number of films are formed on a thin substrate. A multi-layer film block is formed on a thickness-increasing substrate and is divided into first optical multi-layer films with a lattice-form incision made in the block so as to be formed into respective chip-form film-forming components, and the surface, opposite to the surface on which the first optical multi-layer films are formed, of the substrate is polished to a level short of causing a deformation or a damage. A second optical multi-layer film such as an anti-reflection film is formed on the surface, opposite to the surface on which the first optical multi-layer films are formed, of a polished substrate base material so as to offset a stress by the films, and is cut.

### FIELD OF THE ART

This invention relates to a method for manufacturing coated chip-like optical parts by depositing coatings on front and back sides of a thin substrate of optical glass, ceramic, metal or synthetic resin material, and cutting and separating the coated substrate into units of coated chip-like parts.

### BACKGROUND OF THE ART

For example, optically functioning parts such as wavelength selector filters, light polarizer and light rotators are used in optical or light communication systems and optical data processing systems. Among these optically functioning parts, there are optical parts which are produced by depositing a multi-layer optical coating on a surface of optical glass, with or without depositing on a surface on the opposite side of the substrate a multi-layer optical coating with optical functions as an anti-reflection film or as a half mirror. It is generally the case that most of these optical parts are provided with optical coatings on the opposite sides an optical glass substrate.

Optical parts or elements like the above-mentioned wavelength selector filters are manufactured by the use of a parallel plane optical glass sheet as a substrate, depositing alternately a high refractivity film layer and a low refractivity film layer to form a multi-layer coating on a surface of the optical glass substrate, while depositing, for example, an anti-reflection coating on a surface on the opposite side of the substrate. The low refractivity film layers in the multi-layer coating are constituted by thin films of silicon dioxide, and high refractivity films are constituted, for example, by thin films of a metal oxide like tantalum oxide or titanium oxide. In this regard, in order to impart desired optical properties to a multi-layer coating, it is the general practice to deposit more than 20 layers of high and low refractivity film layers. Especially in the case of optical communication systems or optical data processing systems which deal with light of high or short wavelengths, it is required to deposit more than 50 layers of optical films and in some case to deposit 200 or more layers of optical films for component parts to be incorporated into optical appliances and equipments which require high precision performances. On the other hand, 4 to 8 layers are deposited when coating an anti-reflection film layers on a surface on the other side of the substrate.

By the way, it has thus far been known in the art that internal stress occurs upon depositing a thin film on a surface of a substrate (e.g., from the Patent Literature 1 below). Therefore, the greater the number of films in a multi-layer coating, the greater becomes the internal stress to cause warping or deformations of the substrate. Internal stress in a multi-layer coating often results in cracking, fracturing or other damages to optical parts at the time of cutting a multitude of chip-like optical parts from a large-size substrate.

In view of the foregoing situations, in the case of Patent Literature 1 mentioned above, an attempt has been made to deposit a multi-layer coating on a mask pattern which is formed on a substrate along cutting lines for use in cutting the deposited coating into units of a desired size in terms of optical parts of ultimate product. It has also been known to provide grooves on a substrate along predetermined cutting lines for the same reason, fitting a wire or magnetic masking material in the grooves prior to depositing a multi-layer coating and removing the masking material after completion of deposition of a predetermined number of film layers (e.g., from Patent Literature 2 below).
PATENT LITERATURE 1: Japanese Laid-Open Patent Application H11-12605
PATENT LITERATURE 2: Japanese Laid-Open Patent Application H9-277395

### DISCLOSURE OF THE INVENTION

### PROBLEMS SOLVED BY THE INVENTION

Since optical parts are employed in various optical appliances and equipments, there has been a strong demand for optical parts which are reduced in size and weight and compact in shape. For example, reductions in size and weight are a must for optical parts to be incorporated into a writing/reading head of an optical disk drive, in consideration of limitations in mounting space and for reduction of the weight of the head assembly.

The method of depositing film layers after masking optical part unit areas on a broad substrate surface as in the above-mentioned prior art is effective as long as the substrate has a certain thickness and as long as the number of depositing film layers is relatively small. In a case where an extremely large number of film layers, for example, more than 100 film layers are deposited on a substrate of a reduced thickness, it is very likely that, due to residual stress, cracking and fracturing at the time of removing the mask after deposition of film layers. That is, deposited multi-layer coating can be damaged during a mask removing operation.

In view of the situations as discussed above, it is an object of the present invention to prevent deformations and damages to a substrate or a coating which usually occur when a coat of an extremely large number of layers is deposited on a thin substrate.

### MEANS FOR SOLVING PROBLEMS

In accordance with the present invention, in order to solve the above-stated objective, there is provided a method for manufacturing coated chip-like optical parts, which comprises the steps of: coating a first multi-layer coat on a first coat depositing surface on one side of a thickened substrate; slitting the first multi-layer coat in a lattice-like pattern and to a depth corresponding to thickness of the first multi-layer coat to divide same into square subdivisions in a unit size of coated chip-like optical parts to be produced; grinding a surface on the other side of the thickened substrate to obtain a parental substrate material of a reduced thickness; depositing a second multi-layer coat on a second coat depositing surface on a ground side of the parental substrate material; and cutting the parental substrate material into units of coated chip-like optical parts of ultimate products; the thickened substrate being initially allotted with a sufficient thickness to prevent deformations caused by deposition of the first multi-layer coat, and later ground down to a reduced thickness sufficient for precluding possibilities of deformations and damages as caused under the influence of stress imposed by slitted subdivisions of the first multi-layer coat.

In the method for manufacturing coated chip-like parts according to the present invention, a low refractivity coat and a high refractivity coat can be deposited in the first and second coat depositing stages. The second multi-layer coat can be imparted with optical properties independent of and different from the first multi-layer coat. Otherwise, arrangements may be made to produce aimed optical properties by the combination of the first and second multi-layer coats. In a case where the first and second multi-layer coats are of different optical properties from each other, each multi-layer coats is deposited on the first or second coat depositing surface in a required number of layers. On the other hand, in a case where the first and second multi-layer coats are combined as an optical element to produce specific optical properties by optical coat layers which are allotted to the first and second coat depositing surfaces, the second multi-layer coat can be deposited on the second coat depositing surface in such a number of layers as to substantially cancel stresses imposed by slitted subdivisions of the first multi-layer coat, for the purpose of preventing deformations, fractures and cracking in a substrate cutting stage.

In this instance, the substrate means a thin optical glass, ceramic, metal or synthetic resin substrate. In the case of an optical element, the substrate is a transparent substrate of optical glass or of plastic, and first and second optical multi-layer coats of desired optical properties are deposited on the substrate. In many cases, the substrates of optical parts are required to have a function of retaining deposited coats. For reducing the size and weight of optical parts, preferably the substrate should be as thin as possible. Especially, in a case where the substrate is of optical glass, the optical parts of end products are light transmitting parts. Therefore, in such a case, the substrate is preferred to be as thin as possible for preventing light attenuations. In any case, the more reduced in thickness, the more the substrate becomes fragile and susceptible to deformations, fractures and cracking. However, according to the invention, the first multi-layer coat is deposited on a thickened substrate, and slits are formed in the first multi-layer coat on the thickened substrate to relieve internal residual stresses, thereby preventing deformations of and damages to the substrate which bears the first multi-layer coat.

The first multi-layer coat may contain 200 layers or more. The greater the number of layers in the first multi-layer coat, the greater thickness should the substrate have to guarantee durability against deformations and damages caused by internal stress as a result of deposition of the first multi-layer coat. The second multi-layer coat to be deposited on the second coat depositing surface is preferred to have optical or other properties. However, the second multi-layer coat may be deposited only for the purpose of canceling internal stress resulting from deposition of the first multi-layer coat.

### EFFECTS OF THE INVENTION

As explained above, according to the present invention, an extremely large number of film layers can be deposited on a thin substrate without causing damages or deformations to a substrate or coated film layers.

### BRIEF DESCRIPTION OF THE DRAWINGS

FIG. 1 An outer view of a thickened substrate and a coated chip-like optical part employed and produced by a method according to the present invention.

FIG. 2 A schematic illustration explanatory of a first coating stage in which a first optical multi-layer coating is deposited on a thickened substrate.

FIG. 3 A schematic illustration explanatory of a slitting stage in which slits are formed in a multi-layer coating which is formed on the thickened substrate in the first coating stage.

FIG. 4 A schematic illustration explanatory of a grinding stage in which the thickened substrate is ground.

FIG. 5 A schematic illustration explanatory of a second coating stage in which an anti-reflection coat is deposited on the other side of the substrate.

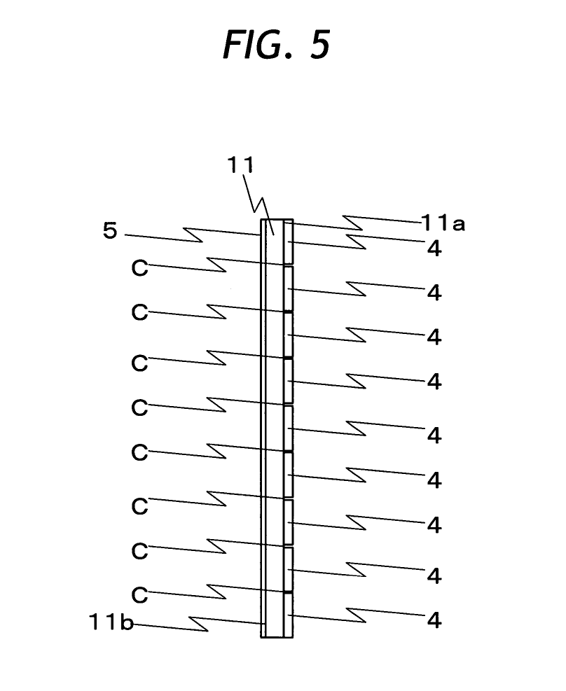

FIG. 6 A schematic illustration explanatory of a cutting stage in which the substrate is cut into optical part units.

FIG. 7 A schematic illustration explanatory of a second coating stage in which a multi-layer optical coating is deposited on a substrate.

### DESCRIPTION OF REFERENCE NUMERALS

1: Thickened substrate
2: Coated chip-like optical part
3: Substrate
4: Optical multi-layer coating
4P: Multi-layer coating
5: Anti-reflection film coating
11a: First coating surface
11b: Second coating surface
40: Second optical multi-layer coating
C: Slit

### BEST MODE FOR CARRYING OUT THE INVENTION

### A. FIRST EMBODIMENT OF THE INVENTION

Hereafter, a first embodiment of the present invention is described with reference to the accompanying drawings. In this instance, the present invention is applied to a process of manufacturing optical parts like wavelength selector filters and polarizer by depositing optical coatings on opposite sides of a substrate of optical glass. Needless to say, the present invention can be applied to substrates other than optical glass, and to optical parts of other functions.

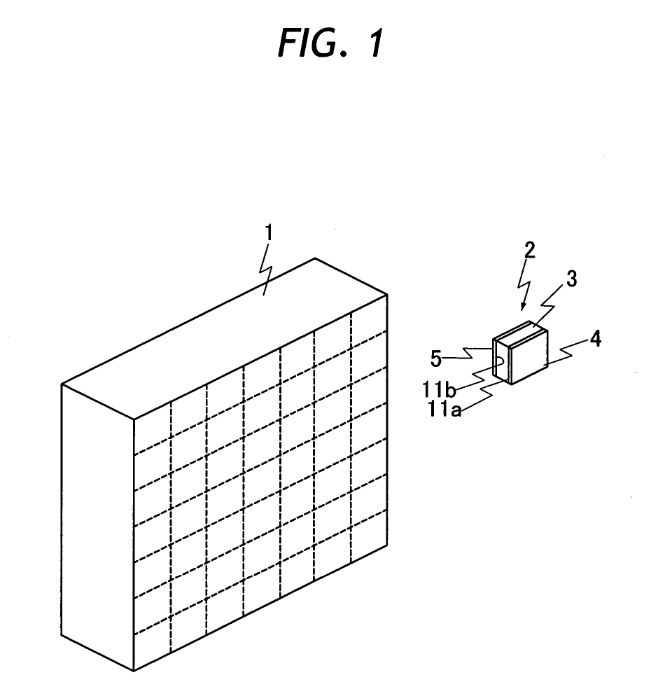

Shown in outer view in FIG. 1 is a thickened substrate 1 and a coated chip-like optical part 2 as an ultimate product. As clear from that figure, the substrate 1 has a large number of chip sections in a matrix as indicated by an imaginary line. The chip-like optical part of the ultimate product has a first optical multi-layer coating 4, which contains 200 to 400 layers or more, deposited on a first coat deposition surface 1a on one side of a thinned-down substrate 3 of optical glass, and an anti-reflection coat 5 is deposited on a second coat deposition surface 11b on the other side of the substrate 3. The thickness of the thinned substrate 3 is approximately 1/10 as compared with that of the thickened substrate 1.

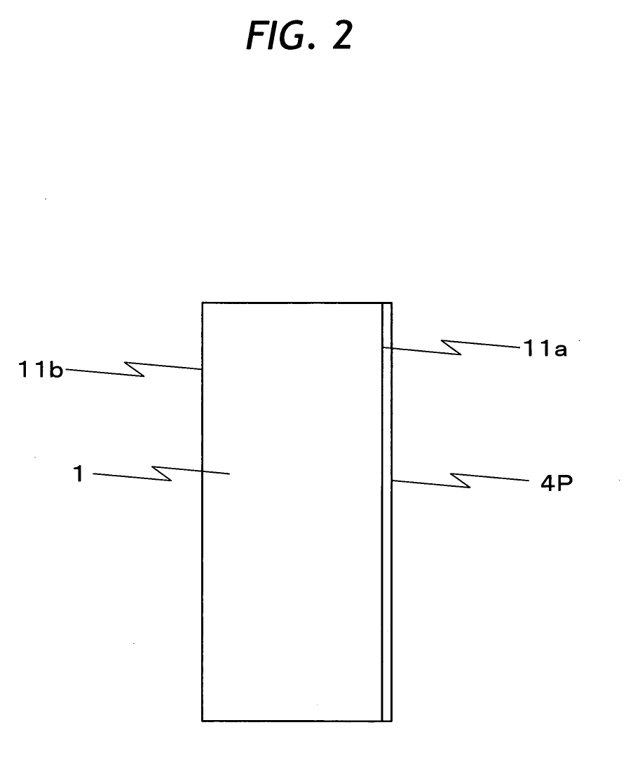

The first optical multi-layer coating 4 is deposited as a multi-layer coating 4P on a first coat depositing surface 11a on one side of the thickened substrate 1. This is the first coat depositing stage shown in FIG. 2. For deposition of an optical coating, it is the general practice to resort to vacuum deposition. However, other methods such as spattering or CVD may be employed for deposition of coating. Further, in this connection, coating may be deposited on the thickened substrate by either a low temperature evaporation process or a high temperature deposition process. Especially, a high temperature evaporation process is desirable because a multi-layer coat 4P of higher strength can be deposited. As for an example of the first optical multi-layer coat 4, a low refractivity film layer of silicon dioxide and a high refractivity film layer of titanium oxide or tantalum oxide are alternately laminated one on another.

As the multi-layer coat 4P is deposited on the thickened substrate 1, stress occurs to the thickened substrate 1 in a compressive (or tensile) direction. And, when the coating reaches a large number of layers, stress corresponding to the number of layers builds up and remain as internal stress. However, the thickened substrate 1 has sufficient strength to endure the residual stress. For example, in a case where an optical multi-layer coat of 20 to 30 μm is deposited by alternately laminating a low reflectivity film and a high reflectivity film in 200 layers as a whole, the thickened substrate 1 can remain free of deformations or damages if it has a thick of 10 mm to 20 mm. Desirably, however, the thickened substrate 1 should have a minimum necessary thickness in consideration of efficiency of a grinding operation in a subsequent stage.

In a succeeding slitting stage, slits are formed into the multi-layer coat 4P on the thickened substrate 1 by the use of a dicing saw or slicing machine. This slitting stage is provided for relieving residual stress which would accumulate if the coating is in the form of multi-layer coating 4P. Residual stress becomes a problem when a coat is deposited on a broad area. This problem of tensile or compressive stress can be substantially solved by dividing the deposited coating into first optical multi-layer coat sections 4 in the form of 1 mm to 2 mm squares. The multi-layer coat 4P which is deposited on a broad area is relieved of residual stress and becomes less susceptible to the problems of deformations, cracking and fracturing, when divided and cut into smaller sections, that is to say, when divided and cut into the first optical multi-layer sections 4.

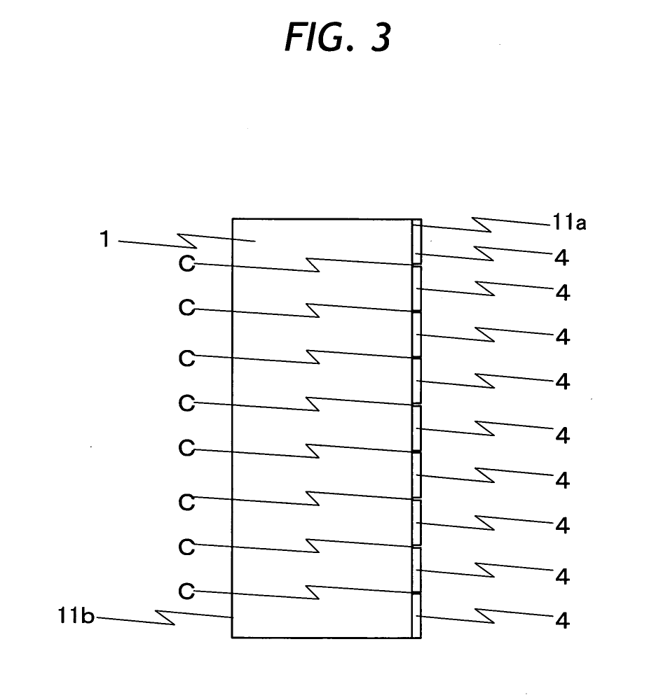

For this reason, as shown in FIG. 3, the multi-layer coat 4P is divided by lattice-like slits C as indicated by imaginary lines in FIG. 1. The subdivisions defined by the lattice pattern correspond to a unit size and shape of coated chip-like parts which are obtained as an ultimate product. The depth of slits is preferably same as the thickness of the multi-layer coat 4P in order to get the subdivided first optical multi-layer sections 4 which are separated from each other as intermediate products for chip-like optical parts. However, it is not a paramount requisite to separate all of subdivided sections completely at this stage. Namely, even if several layers were left uncut in some areas, it would not give rise to any problem in particular from the standpoint of relieving residual stress.

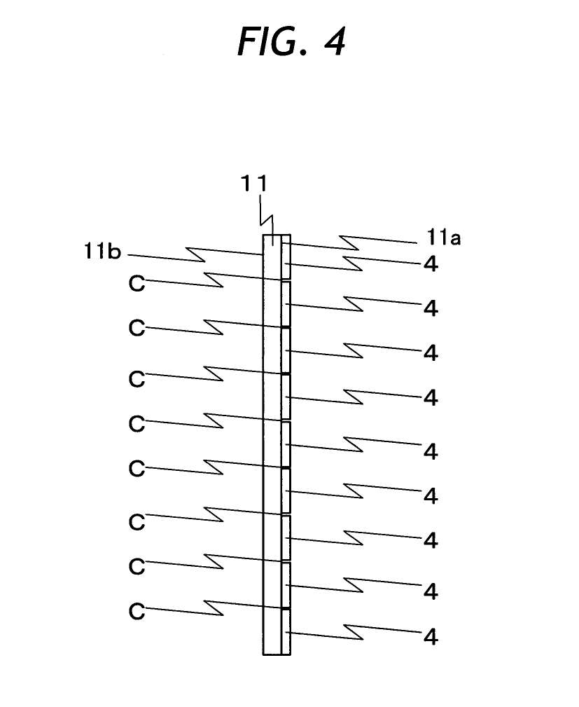

After slitting the multi-layer coat 4P in a lattice-like pattern to subdivide same into first optical coat sections 4 as described above, the thickened substrate 1 bearing the subdivided optical coat sections 4 is retained in position by means of a suction holder or water adhesion. Then the other side of the thickened substrate 1, away from the side bearing the subdivided first optical coat sections 4, is ground to obtain a parental substrate material 11. This is a substrate grinding stage as shown in FIG. 4. At this time, the thickness of the parental substrate material 11 is ground down to a measure which corresponds to the thickness of coated chip-like optical parts 2 of ultimate products. However, it is necessary for the parental substrate material 11 to have a sufficient thickness for enduring stress which is imposed from the side of the first optical multi-layer coat sections 4. The stress on the parental substrate material 11 is lessened by slitting the multi-layer coat 4P but still remains in a certain degree. Therefore, in case the thickened substrate 1 is ground and thinned down to an excessively degree, there are possibilities of the parental substrate material 11 being deformed or fractured under the influence of residual stress attributable to the first optical multi-layer coat 4. Therefore, in the present embodiment, on the side opposite from the side of the first optical multi-layer coat 4, the thickened substrate 1 is ground only to such an extent which will preclude the possibility of cracking or fracturing of the parental substrate material 11 under the influence of residual stress imposed by the first optical multi-layer coat 4. In this connection, grinding machines which have been widely known in the art can be applied for grinding the thickened substrate 1.

By grinding the thickened substrate 1 as described above, the parental substrate material 11 is thinned down approximately to a thickness of 1 mm to 2 mm. The reduction in thickness of the substrate 3 is desirable not only from the standpoint of reducing the size and weight of optical parts of ultimate products but also from the standpoint of suppressing attenuation of light which occurs on transmission through the substrate 3. Further, in grinding the thickened substrate 1 to a target thickness, it is desirable to hold the amount of stock removal to a minimum. Accordingly, desirably the thickness of the thickened substrate 1 is set at a minimum necessary value for preventing warping and deformation in the coat depositing stage, taking into account of the number of film layers in and the coating material of the first multi-layer coat 4.

By the above-described grinding operation, the parental substrate material 11 is ground to a predetermined thickness, and a second coat depositing surface 11b, on the opposite side from the first coating depositing surface 11a with the first optical multi-layer coat 4, is polished up to a mirror state. The parental substrate 11 is then dismantled from the grinding machine and sent to a second coat depositing stage. In the case of the present embodiment, an anti-reflection coat 5 is deposited on the second coat depositing surface 11a. Although the parental substrate material 11 has been thinned down in the preceding grinding stage, it still has sufficient thickness for preventing fracturing in the second coat depositing stage. Accordingly, the work piece can be handled very easily, it is possible to employ high temperature evaporation for vacuum deposition. As a result, a stronger coat can be deposited.

In the second coat depositing stage, an anti-reflection coat 5 is deposited on the second coat depositing surface 11b of the parental substrate material 11. At this time, the anti-reflection coat 5 can be deposited in a thickness which will offset the residual stress resulting from deposition of the first optical multi-layer coat 4. Namely, generally an anti-reflection coat 5 contains 4 to 6 layers. However, in a case where large residual stress is imposed as a result of deposition of the first optical coat 4, an anti-reflection coat 5 of 10 to 20 layers or more than 20 layers may be deposited for the purpose of offsetting the residual stress. In the present embodiment, the anti-reflection coat 5 is deposited on the parental substrate material 11 in the second coat depositing stage in such a way as to cancel the residual stress resulting from deposition of the first optical coat 4, preventing deformations, cracking or fracturing of the parental substrate material 11 in a cutting stage which will be described hereinlater.

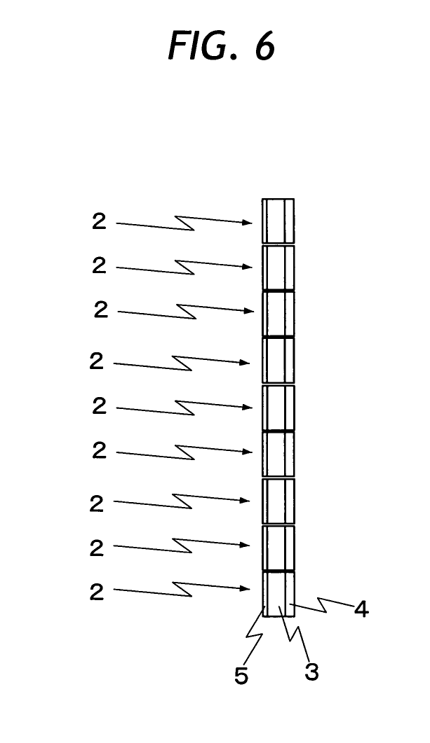

After depositing an optical coat on the first and second coat depositing surfaces 11a and 11b, the parental substrate material 11 is cut into units of coated chip-like optical parts. This is a cutting stage which is shown in FIG. 6. Generally, at the time of cutting the parental substrate material 11 of optical glass, the parental substrate material is susceptible to deformation, cracking or fracturing when an external force is applied thereto by the action of a cutting blade. However, according to the present invention, possibilities of deformations, cracking and fracturing are precluded, because, by slitting, the second coat depositing surface 11a of the parental substrate material 11 is relieved of the stress resulting from deposition of the first optical coat 4 on the first coat depositing surface 11a, and the anti-reflection coat 5 is deposited in such a way as to cancel residual stress in the parental substrate material 11 as mentioned above. The parental substrate material 11 may be cut either from the side of the first coat depositing surface 11a or from the side of the second coat depositing surface 11b. Further, a dicing saw or a slicing machine can be used for cutting the parental substrate material 11.

### B. SECOND EMBODIMENT OF THE INVENTION

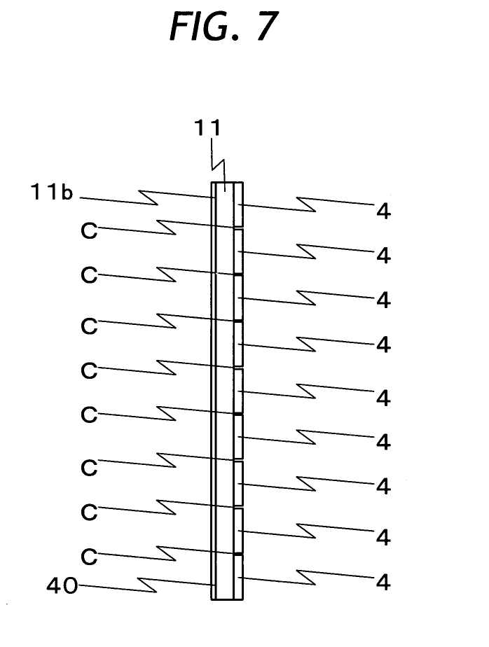

According to a second embodiment of the present invention, in addition to deposition of the first optical multi-layer coat 4 on the first coat depositing surface 11a, a second optical multi-layer coat 40 is deposited on the second coat depositing surface 11b as shown in FIG. 7 to secure desired optical properties different from the optical parts of the foregoing first embodiment in which an optical multi-layer coat and an anti-reflection coat are deposited on the first and second coat depositing surfaces 11a and 11b. Namely, in this case, desired optical properties are generated by cooperation of optical multilayer coatings which are formed on the front and rear sides of the substrate. The second optical multi-layer coat 40 has to be deposited in such a way as to cancel the residual stress resulting from deposition of the first optical multi-layer coat. For this purpose, for example, in a case where the total number of layers in optical multi-layer coatings is 200 layers, at least half or more than half of the total number of layers should be allotted to the first optical multi-layer coat 40, depositing a necessary number of layers for the second optical coat depending upon the degree of stress acting on the parental substrate material 11 for cancellation of residual stress. For instance, a 150-layer optical coat is deposited on the first coat depositing surface 11a, while depositing 50-layer optical coat on the second coat depositing surface 11b. As a consequence, it becomes possible to preclude cracking and fracturing in the cutting stage in a secure manner to produce optical parts which are free of distortions or other flaws and are improved in optical properties.

What is claimed is:

1. A method for manufacturing coated chip-like optical parts, comprising the steps of:
coating a first multi-layer coat on a first coat depositing surface on one side of a thickened substrate;
slitting said first multi-layer coat in a lattice-like pattern and to a depth corresponding to thickness of said first multi-layer coat to divide same into square subdivisions in a unit size of coated chip-like optical parts to be produced;
grinding a surface on the other side of said thickened substrate to obtain a parental substrate material of a reduced thickness;
depositing a second multi-layer coat on a second coat depositing surface on a ground side of said parental substrate material; and
cutting said parental substrate material into units of coated chip-like optical parts of ultimate products;
said thickened substrate being initially allotted with a sufficient thickness to prevent deformations caused by deposition of said first multi-layer coat, and later ground down to a reduced thickness sufficient for precluding possibilities of deformations and damages as caused under the influence of stress imposed by slitted subdivisions of said first multi-layer coat.

2. A method for manufacturing coated chip-like optical parts as defined in claim 1, wherein said first and second multi-layer coats are optical coats different from each other in optical properties.

3. A method for manufacturing coated chip-like optical parts as defined in claim 1, wherein both of said first and second multi-layer coats are optical multi-layer coats, said second optical multi-layer coat being deposited in a number of layers suitable for substantially canceling stress imposed by slitted subdivisions of said first optical multi-layer coat and adapted to generate aimed optical properties in cooperation with said first optical multi-layer coat.
